(19) United States
(12) Patent Application Publication
(10) Pub. No.: US 2026/0152108 A1
(43) Pub. Date: Jun. 4, 2026

(54) Stowing System and Vehicle Including the Same

(71) Applicants: Hyundai Motor Company, Seoul (KR); Kia Corporation, Seoul (KR)

(72) Inventors: Hong Heui Lee, Hwaseong-Si (KR); Dong Ha Kim, Hwaseong-Si (KR); Jin Young Yoon, Hwaseong-Si (KR); Kyung Hwan Kim, Hwaseong-Si (KR)

(21) Appl. No.: 19/300,024

(22) Filed: Aug. 14, 2025

(30) Foreign Application Priority Data
Dec. 3, 2024 (KR) 10-2024-0176967

(51) Int. Cl. B60N 3/10; B60R 16/03

(52) U.S. Cl. CPC B60N 3/104; B60N 3/103; B60R 16/03

(57) ABSTRACT

A stowing system includes a docking station and a container including at least one component configured to receive power by being docked with the docking station. The container is configured to be separable from the docking station.

### CROSS-REFERENCE TO RELATED APPLICATION

This application claims under 35 U.S.C. § 119(a) the benefit of priority from Korean Patent Application No. 10-2024-0176967, filed on Dec. 3, 2024, the entire contents of which are incorporated herein by reference.

### TECHNICAL FIELD

The present disclosure relates to a stowing system of a vehicle.

### BACKGROUND

In internal combustion engine vehicles, an engine, a transmission, etc., may be installed in a space below a hood at the front part of the vehicle. Electric vehicles driven by an electronic motor do not require an engine, a transmission, etc. Therefore, an empty space at the front part of the electric vehicle may be used for other purposes.

The above empty space at the front part of the vehicle is called a frunk (a portmanteau of “front” and “trunk”), while the rear space of the vehicle is called a trunk. The frunk may be used for storage purposes, for example, and for other purposes.

The above information disclosed in this Background section is only for enhancement of understanding of the background of the disclosure and therefore it may contain information that does not form the prior art that is already known to a person of ordinary skill in the art.

### SUMMARY OF THE DISCLOSURE

The following summary presents a simplified summary of certain features. The summary is not an extensive overview and is not intended to identify key or critical elements.

Systems, apparatuses, and methods are described for a stowing system and vehicle including a stowing system. A stowing system may comprise: a docking station installed in a frunk of a vehicle; and a container comprising at least one component configured to, based on the container being docked with the docking station, receive power. The container may be configured to be separable from the docking station.

Also, or alternatively, vehicle may comprise: a docking station provided in a frunk located at a front part of the vehicle; and a container comprising at least one component configured to, based on the container being docked with the docking station, receive power. The container may be configured to be separable from the docking station.

Also, or alternatively, a vehicle may comprise: a docking station provided in a frunk located at a front part of the vehicle; a container comprising at least one component configured to receive power by being docked with the docking station; a control device; and an interface associated with the control device. The control device may comprise: one or more processors; and a memory storing instructions that, when executed, configure the one or more processors to control an operation of the at least one component; and wherein the interface is configured to output an indication of one or more of: the power received by the at least one component; or the operation of the at least one component.

These and other features and advantages are described in greater detail below.

### BRIEF DESCRIPTION OF THE DRAWINGS

The above and other features of the present disclosure are described herein in detail with reference to certain examples thereof illustrated in the accompanying drawings which are given hereinbelow by way of illustration only, and thus are not limitative of the present disclosure. The included drawings are as follows:

FIG. 1 illustrates a frunk of a vehicle including a docking station of a stowing system according to one example of the present disclosure;

FIG. 2 illustrates a container of the stowing system according to one example of the present disclosure;

FIG. 3 illustrates a state in which the container of FIG. 2 is docked with the station of FIG. 1;

FIG. 4 is an enlarged view of portion R1 of FIG. 1;

FIG. 5 illustrates a connector portion of the container of FIG. 2, as viewed from direction V1;

FIG. 6 illustrates a state in which the container of the stowing system according to one example of the present disclosure is opened;

FIG. 7 illustrates a heating pad for the stowing system according to one example of the present disclosure;

FIG. 8 illustrates a state in which the container including a vent according to one example of the present disclosure is opened;

FIG. 9 illustrates a blower of the stowing system according to one example of the present disclosure;

FIG. 10 illustrates a state in which the container including a cooling module is opened;

FIG. 11 illustrates the cooling module of the stowing system according to one example of the present disclosure;

FIG. 12 illustrates the operation of the cooling module of the stowing system according to one example of the present disclosure;

FIGS. 13 and 14 illustrate cold air discharge and warm air discharge of the cooling module of the stowing system according to one example of the present disclosure;

FIG. 15 illustrates a state in which the container including holes of the stowing system according to one example of the present disclosure is opened;

FIG. 16 illustrates a state in which the cooling module is mounted in the container in the stowing system according to one example of the present disclosure;

FIG. 17 illustrates the container including a window and a net of the stowing system according to one example of the present disclosure;

FIG. 18 illustrates the container including the blower of the stowing system according to one example of the present disclosure;

FIG. 19 is a cross-sectional view taken along line S1-S1 of FIG. 18;

FIGS. 20 and 21 illustrate a state in which the stowing system according to one example of the present disclosure functions as a styler;

FIG. 22 is a cross-sectional view taken along line S2-S2 of FIG. 20;

FIGS. 23, 24, and 25 illustrate a state in which the stowing system according to one example of the present disclosure functions as a refrigerator;

FIGS. 26, 27, and 28 illustrate a state in which the stowing system according to one example of the present disclosure functions as a pet cage;

FIG. 29 is a cross-sectional view taken along line S3-S3 of FIG. 27; and

FIG. 30 is a cross-sectional view taken along line S4-S4 of FIG. 28.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions set forth in the examples of the present disclosure will be merely exemplarily given to describe the examples depending on the concept of the present disclosure, and the examples depending on the concept of the present disclosure may be embodied in different forms. Further, the present disclosure should not be construed as being limited to the examples set forth herein, and it will be understood that the present disclosure includes all modifications, equivalents, or substitutes included in the spirit and technical scope of the disclosure.

In the following description of the examples, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the following description to refer to the same or like parts. The terminology used herein is for the purpose of describing particular examples only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

An interface/display herein may be a device through which a control device and/or human user can interact with a device (e.g., the stowing system disclosed herein and/or one or more associated components discussed herein. The interface may include an input interface that can receive an input from the human user and/or control device and/or an output interface through which data or information can be output to the control device and/or to the human user. An input interface may include, for example, a button, a knob, a toggle, a switch, a dial, a slider, a keyboard, a touchscreen, a microphone, a camera, a wheel, a pedal, a lever, etc. An output interface may include, for example, a light, a lamp, an indicator, a screen, a display, a console, a meter, a gauge, a speaker, etc., and/or a communication channel/protocol with the control device, etc.

A control device may include a communication device communicating with other control devices and/or a sensor to control one or more functions and/or operations in charge, a memory storing an operation system, a logic command, and input/output information, and/or one or more processors performing determination, calculation, and decision necessary for controlling the function in charge. A control device may include, for example, a processor, a central processing unit (CPU), a microchip, a logic, an application-specific integrated circuit (ASIC), memory, etc. A control device may manipulate and/or control other components in the system (e.g., vehicle).

Hereinafter, reference will be made in detail to various examples of the present disclosure, examples of which are illustrated in the accompanying drawings and described below.

As described above, a frunk refers to an interior space of the front part of a vehicle. The frunk may perform a storage function, but additional functions may be added. The position and height of the frunk may make frunks more convenient to use for storage and such additional functions than trunks. For example, a vehicle air conditioning filter may be replaced through the frunk, or the frunk may be used as a seat during camping, parking, tailgating, drive-in theater-going, etc. However, the number of cases of illegally/unsafely modifying vehicles to use the frunk for desired purposes and unmet needs is increasing, and occurrence of safety incidents resulting therefrom is also increasing. For example, a fire may be caused by ad hoc/amateur installation of a parking heater.

Accordingly, the present disclosure provides a stowing system that allows a frunk to be safely used for multiple purposes so as to increase the marketability, functionality, and user convenience of a vehicle.

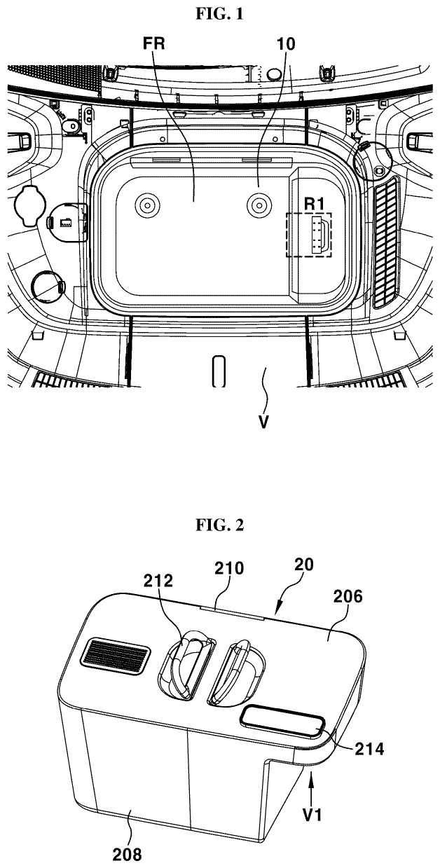

As shown in FIG. 1, a vehicle V may include a frunk FR. The frunk FR may be provided at the front part of the vehicle V. Specifically, the frunk FR may be provided in a space below a hood of the vehicle V. In one example, the vehicle V may include an electric vehicle. However, the vehicle V may include any other type of vehicles including a frunk FR. The vehicle may include passenger vehicles, commercial vehicles, trucks, buses, motorcycles, and/or bicycles.

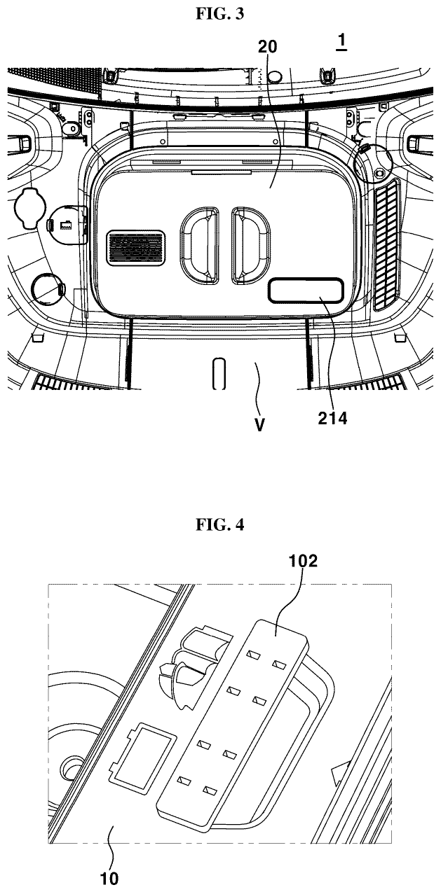

A stowing system 1 according to one example of the present disclosure may use the frunk FR of the vehicle V. As shown in FIGS. 2 and 3, the stowing system 1 enables the frunk FR to be utilized for multiple purposes through the associated operation of a docking station 10 and a container 20. In one example, the docking station 10 may be provided in the frunk FR of the vehicle V. The container 20 may be disposed to be insertable into the frunk FR or the docking station 10. The container 20 may be separable from the docking station 10.

As shown in FIG. 4, the docking station 10 may be configured to supply power to the container 20 when the container is docked therein. The docking station 10 may be configured to allow the container 20 to communicate (e.g., electronically, wirelessly, wiredly, etc.) with the vehicle V. In one example, the docking station 10 may include a docking power supply 102. The docking power supply 102 may be configured to supply power supplied from the vehicle V to a target (e.g., the container 20 and/or one or more devices in the container 20) electrically connected to the docking power supply 102. As a non-limiting example, the docking power supply 102 may be connected to a power source (e.g., an auxiliary battery, a main battery, or any other power source, etc.) of the vehicle V. In one example, the docking power supply 102 may enable communication between the vehicle V and the target (e.g., the container 20 and/or one or more devices in the container 20) electrically connected to the docking power supply 102. In one example, the docking power supply 102 may be configured to include at least eight pins applied in consideration of an operating signal.

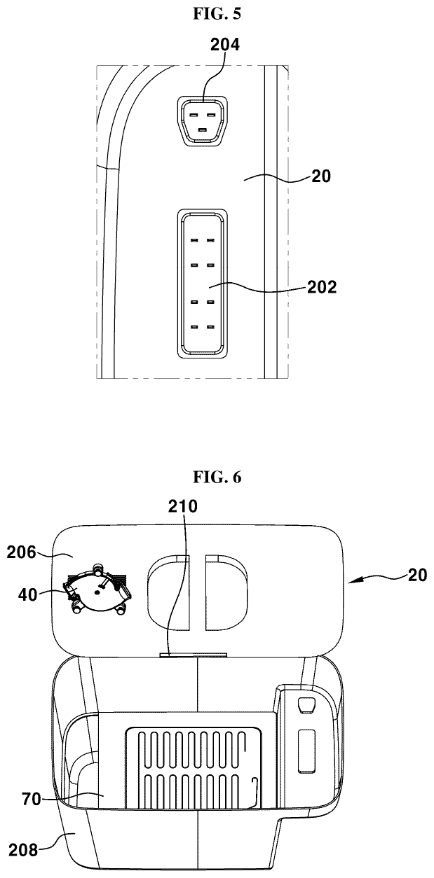

The container 20 may be detachably disposed on the docking station 10. The container 20 may be electrically connected to the docking power supply 102 of the docking station 10 (e.g., by docking in the docking station 10). As shown in FIG. 5, in one example, the container 20 may include a docking power connector 202. When/if the container 20 is disposed on/in the docking station 20, the docking power connector 202 may be electrically connected to the docking power supply 102.

According to an example, the container 20 may include an external power connector 204. The container 20 may be configured to be connected to an external power source through connection of a power line so as to be able to receive power even when/if the container 20 is not placed on the docking station 10.

The container 20 may be openable and/or closable. In an example, the container 20 may include a lid 206 and a holder 208. The lid 206 may be configured to rotate relative to the holder 208 (e.g., hingedly connected to the holder). In an example, the lid 206 may be coupled to the holder 208 by a hinge 210. Also, or alternatively, the lid 206 may be separable from the holder 208.

The container 20 may include a handle 212 (e.g., as shown in FIG. 2). In an example, the handle 212 may be provided on the lid 206. The handle 212 may facilitate transport of the container 20. Specifically, the handle 212 may be provided to facilitate insertion and/or removal of the container 20 into or from the frunk FR. The handle 212 may be provided in a form that retractably protrudes (e.g., by rotation, as in the illustrated example) or may be formed in various other known forms. The handle may be configured to retract and/or fold flush with the lid when not being used for more efficient use of space.

The container 20 may include a display 214 (e.g., a user interface and/or touch-screen display). In an example, the display 214 may be provided on the lid 206. The display 214 is configured to enable checking of the operating status of the stowing system 1 and input of a manipulating operation. In an example, the display 214 may perform a notification function of indicating the operating status of the container 20. In an example, the display 214 may include an operating button configured to function to manipulate/control the operation of the container 20. The display 214 may be configured to indicate whether power is supplied to the container 20. Supply of the power may be selected using the display 214. The display 214 may be configured to adjust the operation of components included in the container 20 and/or to indicate the components and/or current operation of the components (e.g., without having to open the container 20). As a non-limiting example, the display 214 may be touch-type. Also, or alternatively, the display/interface may be provided separately from the container (e.g., as part of a different interface/display in the vehicle, such that user input to control the stowing system 1 may be provided via user input from inside the car and/or via another interface, such as on a phone, remote controller, etc.). A display 214 will be discussed herein as provided on the container 20, but one skilled in the art will understand similar functions may be provided by a separate display and/or interface. Also, or alternatively, an interface other than or in addition to a display may be provided (e.g., an audio interface, a tactile interface, etc.).

The display 214 (and/or interface) may be associated with and/or comprise one or more control devices (e.g., a controller, a control unit, etc.). The one or more control devices may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like.

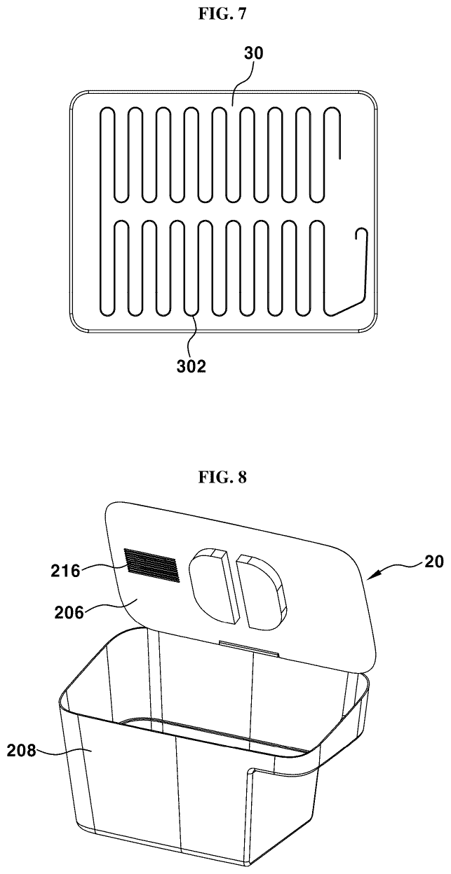

As shown in FIGS. 6 and 7, the container 20 may include a heating pad 30. The heating pad 30 may be attached to the bottom surface and/or the side wall of the container 20. The heating pad 30 may be configured to heat the inside of the container 20.

The heating pad 30 may be electrically connected to the docking power connector 202 and/or the external power connector 204 to be operated. In an example, the heating pad 30 may include a heating wire 302. The heating wire 302 may be configured to receive power and generate heat.

Referring to FIG. 8, the container 20 may include a vent 216. In an example, the vent 216 may be provided in the lid 206. The vent 216 may enable air exchange between the outside and the inside of the container 20. As a non-limiting example, the vent 216 may include a grid or comb-patterned shape. In an example, the vent 216 may be closable to control an amount of air exchange between the outside and the inside of the container 20.

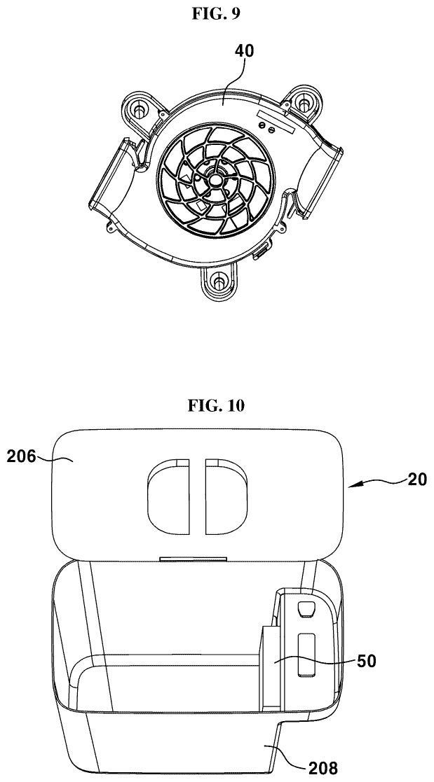

As shown in FIGS. 6 and 9, the container 20 may include a blower 40. In an example, the blower 40 may be mounted in the vent 216. The blower 40 may be configured to forcibly discharge air from inside the container 20 to the outside of the container 20 through the vent 216. The blower 40 may be electrically connected to the docking power connector 202 and/or the external power connector 204. The blower 40 is configured to receive power and rotate to form a flow of air. Also, or alternatively, the blower 40 may be configured to forcibly pull air from outside the container 20 into the container 20 through the vent 216.

As shown in FIG. 10, the container 20 may include a cooling module 50 (e.g., a heat exchanger, a cooling device, a thermoelectric cooler, etc.). The cooling module 50 may be configured to lower the temperature in the container 20. In an example, the cooling module 50 may be operated based on supplied power. The cooling module 50 may be electrically connected to the docking power connector 202 and/or the external power connector 204 to receive power.

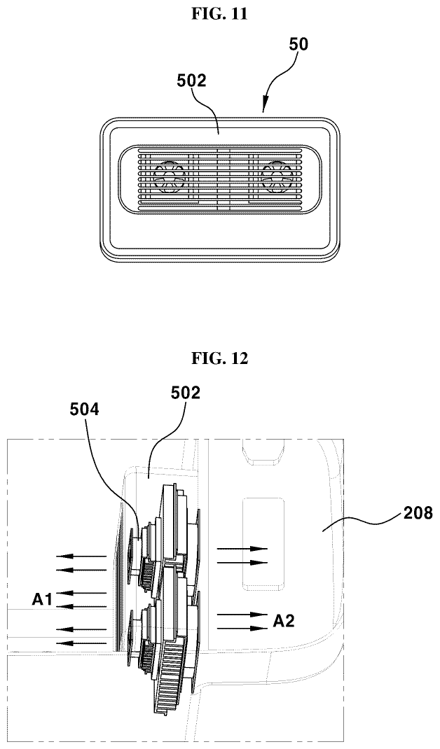

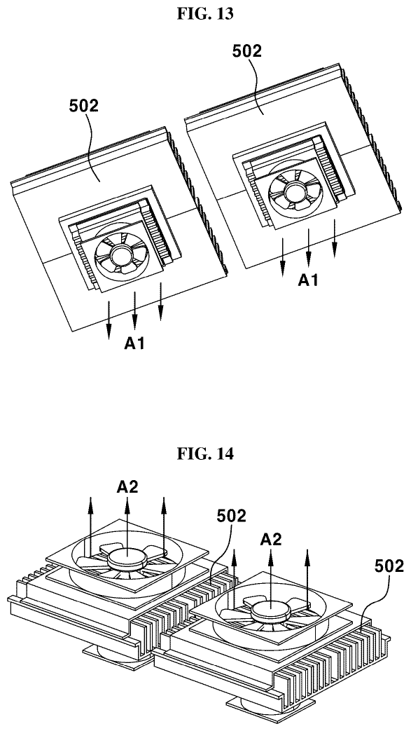

As shown in FIGS. 11 and 12, in an example, the cooling module 50 may include a case 502 and one or more Peltier elements 504. The one or more Peltier elements 504 may be disposed in the case 502. The one or more Peltier elements 504 may be configured/oriented/positioned to supply cold air A1 into the container 20 and warm air A1 to the outside of the container 20 through the Peltier effect. As shown in FIG. 13, the cold surface on one side of the Peltier element 504 may be configured to cool air A1 and the cold air A1 may be supplied to the interior of the container 20 through rotation of a fan or the like. As shown in FIG. 14, the hot surface on the other side of the Peltier element 504 may be configured to warm air A2 and the warm air A2 may be discharged through rotation of a fan or the like.

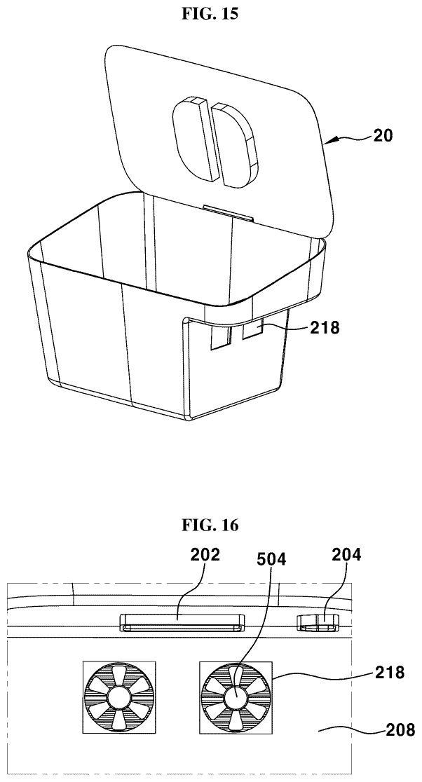

As shown in FIGS. 15 and 16, the container 20 may include one or more holes 218. The warm air A2 from the Peltier element 504 may be discharged to the outside through the one or more holes 218. In addition, the cold air A1 may be discharged into the container 20 through an opening formed through the case 502.

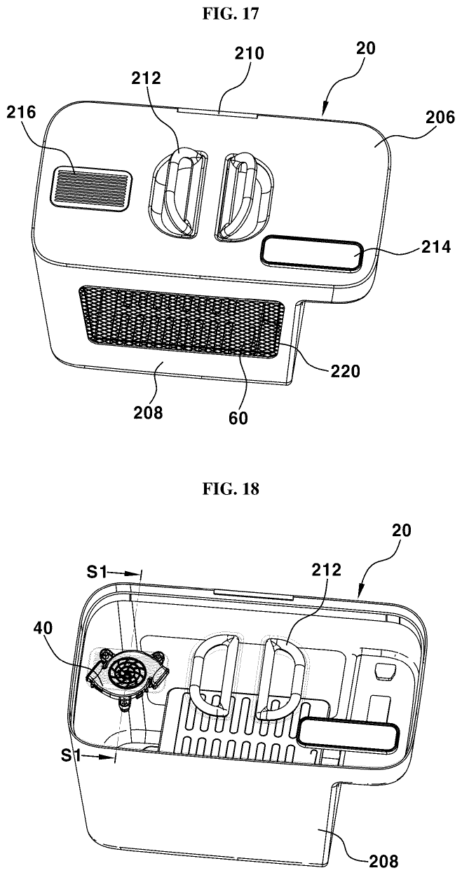

Referring to FIG. 17, the container 20 may include a window 220. In an example, the window 220 may be formed in the holder 208 (e.g., to view through a side wall of the holder 208). A net 60 may be disposed in the window 220. A view between the inside and the outside of the container 20 may be secured through the net 60.

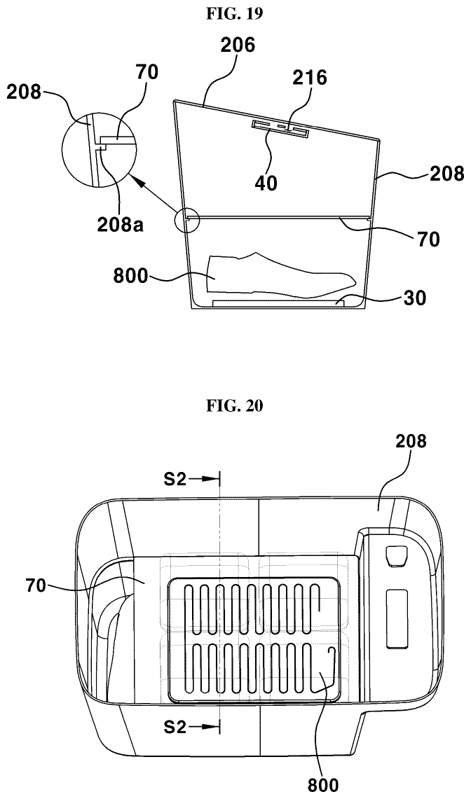

As shown in FIGS. 18 and 19, the container 20 may include one or more partitions 70. The partition 70 may be disposed at a predetermined position of the holder 208. The partition 70 may divide the space of the container 20 so that a large number of items 800 may be disposed or a neat arrangement may be enabled. In an example, the holder 208 may be provided with one or more protrusions 208a. The partition 70 may be positioned on the protrusion 208a. Although, in the illustrated example, only one protrusion 208a is shown, a plurality of protrusions 208a may be formed along the holder 208.

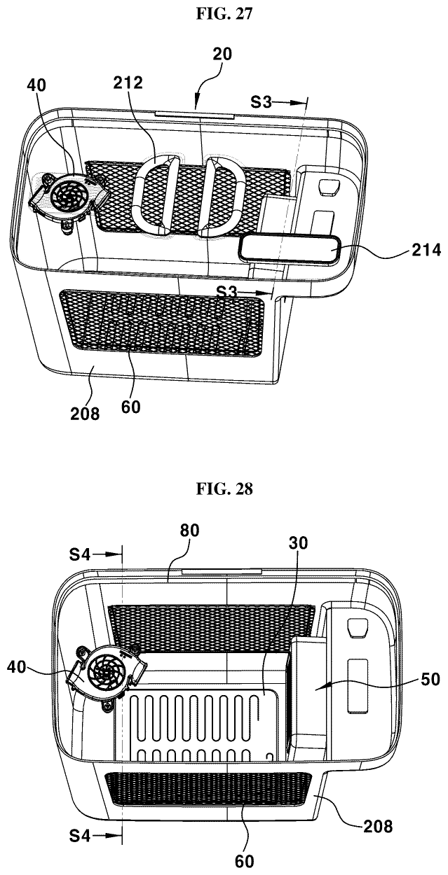

According to an example of the present disclosure, the container 20 may include one or more light emitting diodes (LEDs) 80 (see FIGS. 27 and 28). The LEDs 80 may be placed in the container 20. The LEDs 80 may perform a lighting function that illuminates the inside of the container 20. The LEDs 80 may be electrically connected to the docking power connector 202 and/or the external power connector 204 to receive power. As a non-limiting example, the LEDs 80 may be surface LEDs.

According to the present disclosure, the stowing system 1 may include the docking station 10 and the docking power connector 202 of the container 20 so that a user may use the frunk RF to exhibit a desired function depending on the situation and purpose. The stowing system 1 may diversify the functions of the frunk FR through the docking station 10 and the container 20 including at least some of the above-described components. Specifically, the stowing system 1 may include a combination of at least some of the heating pad 30, the blower 40, the cooling module 50, the net 60, the partition 70, or the LEDs 80, to implement a required function.

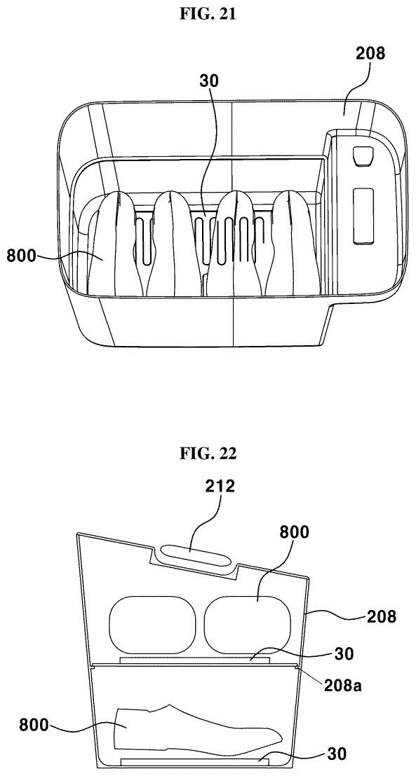

According to an example of the present disclosure, as shown in FIGS. 20 to 22, the stowing system 1 is configured to function as a styler.

The stowing system 1 configured to perform the styler function may include at least one of the blower 40 or the heating pad 30. Items 800, such as shoes and/or towels, stored in the container 20 may be dried and/or deodorized by the blower 40 and the heating pad 30.

The stowing system 1 configured to perform the styler function may include the partition 70. The partition 70 may be positioned on the protrusion 208a formed on the holder 208, and items 800 may be placed on the bottom surface of the holder 208 and each partition 70. Thereby, a large number of items 800 may be disposed in the container 20 and the arrangement of the items 800 may be facilitated. In the illustrated example, shoes are disposed on the first floor, which is the bottom surface of the holder 208, and towels are disposed on the second floor, above the partition 70. A heating pad 30 may also, or alternatively, be disposed on the partition 70. The heating pad(s) 30 may facilitate drying of the items 800 placed on each surface.

The power of the stowing system 1 configured to perform the styler function may be supplied from the vehicle V through the docking power connector 202. In an example, when the vehicle is turned off, the power of the stowing system 1 may be turned off. The power of the stowing system 1 may be turned (e.g., back) on by a power button of the display 214 depending on user selection so that the stowing system 1 may be operated (e.g., even if the vehicle is turned off). The display 214 may be provided with an operation button that may control the air volume of the blower 40 and/or may be configured to adjust the air volume (e.g., depending on user selection/input). The display 214 may be provided with an operation button that may adjust the temperature of the heating pad 30. The heating temperature may also, or alternatively, be adjusted depending on user selection. In an example, the container 20 may receive power from an external power by the external power connector 204 to perform the styler function.

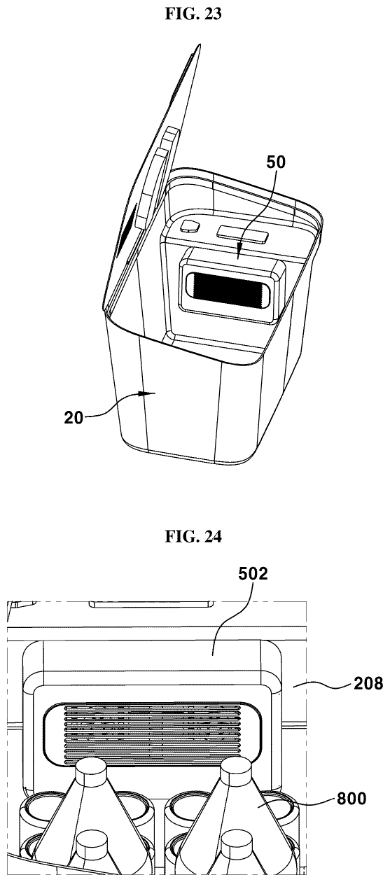

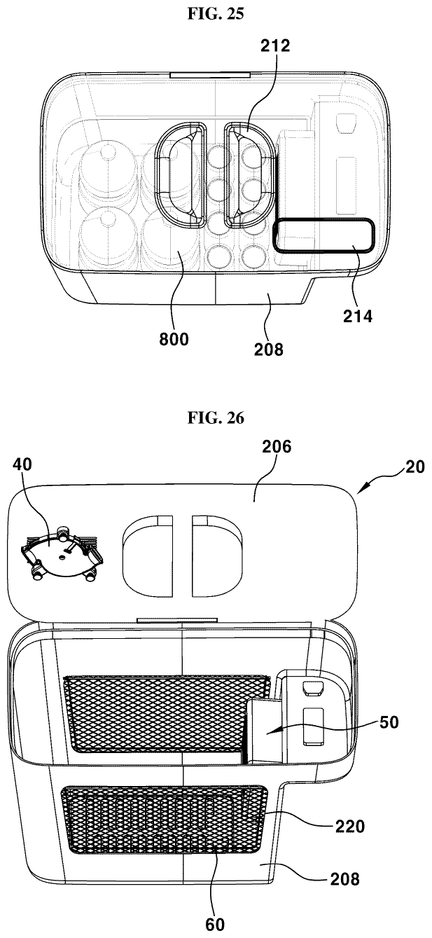

According to another example of the present disclosure, as shown in FIGS. 23 to 25, the stowing system 1 is configured to function as a refrigerator. In cases in which outdoor cooking is required, such as camping and/or car camping, and/or in food trucks or refrigerated transport vehicles, a refrigeration function is essential. In addition, the refrigeration function may be required/useful in vehicles for leisure activities, shopping, etc. However, this may cause space shortage to install a refrigerator in the limited space inside a vehicle. Since the frunk FR is located under the hood, the problem of the space shortage can be resolved, and noise and/or heat of implementing the refrigeration function is less likely to cause any issues. The stowing system 1 may be located in the front part of the vehicle, thereby providing ease of use.

The stowing system 1 configured to perform the refrigerator function may include the cooling module 50. Items 800 to be cooled, such as fresh water and beverages that require refrigeration, food that requires refrigeration, etc., may be placed in the container 20. When/if the container 20 is docked with the docking station 10 and in a state in which power is supplied, the cooling module 50 may be operated. Through the operation of the cooling module 50, cold air may be supplied to the inside of the container 20 and warm air may be discharged to the outside of the container 20.

The power of the stowing system 1 configured to perform the refrigerator function may be supplied from the vehicle V through the docking power connector 202. In an example, when/if the vehicle is turned off, the power of the stowing system 1 may be turned off. The power of the stowing system 1 may be turned (e.g., back) on by the power button of the display 214 (e.g., depending on user selection/input) so that the stowing system 1 may be operated. The display 214 may be provided with an operation button that may adjust the temperature of the cooling module 50 and is configured to adjust the temperature of the cooling module 50 depending on user selection.

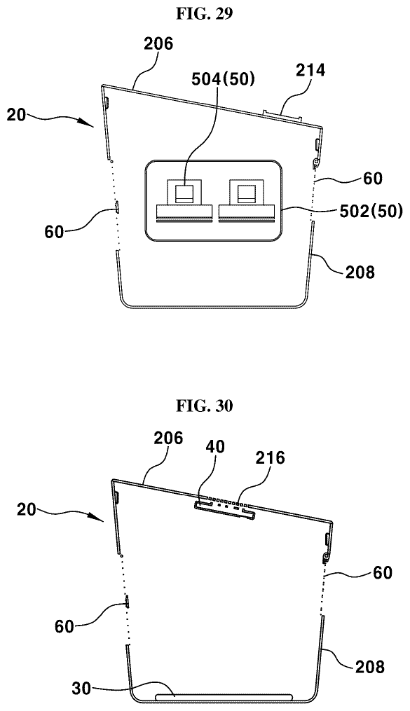

According to an example of the present disclosure, as shown in FIGS. 26 to 30, the stowing system 1 may be configured to function as a pet cage. When/if the vehicle is moved/used for activities with a pet, the stowing system 1 may function as a pet cage. This stowing system 1 may provide the pet with a comfortable and safe moving experience.

The stowing system 1 configured to function as a pet cage may include the blower 40, the cooling module 50, and the heating pad 30, as shown in FIG. 26. When/if the container 20 is docked with the docking station 10, the blower 40, the cooling module 50, and the heating pad 30 may be placed in an operable state. By circulating air in the container 20 by operating the blower 40, a comfortable environment may be created within the container 20. By operating the cooling module 50 and/or the heating pad 30 (e.g., depending on the temperature measured by a temperature sensor inside and/or around the container 20), the inside of the container 20 may be maintained at an appropriate temperature.

The container 20 may further include the net 60. In order to ensure that the pet has a clear view while receiving adequate ventilation, but still feels a sense of stability, the net 60 may be placed in the container 20 instead of/without a transparent window.

As shown in FIG. 27, the container 20 may further include the LEDs 80. The LEDs 80 may be disposed so that the inside of the container 20 may be maintained at an appropriate brightness. For example, the LEDs 80 may be operated as a mood light. The LEDs 80 may be maintained in an operable state when/if the container 20 is docked with the docking state 10. The LEDs 80 may be maintained in the operable state when the container 20 is connected to the external power connector 204. The on/off of the LEDs 80 may be controlled by a button provided on the display 214.

The power of the stowing system 1 may be supplied from the vehicle V through the docking power connector 202. In an example, when/if the vehicle is turned off, the power of the stowing system 1 may be turned off. The power of the stowing system 1 may be turned (e.g., back) on by the power button of the display 214 (e.g., depending on user selection/input) so that the stowing system 1 may be operated. The display 214 may be provided with the operation button that may adjust the air volume of the blower 40 and/or may be configured to adjust the air volume depending on user selection. The display 214 may be provided with the operation button that adjusts the temperature of the heating pad 30. The heating temperature may also be controlled depending on user selection.

The stowing system 1 according to the present disclosure includes the components that may be used in common and may change the purpose thereof depending on a combination of the components. For example, the stowing system 1 may implement a desired function through a combination of the components included in the container 20, in addition to the function of a refrigerator, a styler, and/or a pet cage.

According to the present disclosure, the stowing system 1 capable of implementing various functions may be operated in conjunction with the frunk FR, thereby being capable of increasing the space utilization of the vehicle.

The present disclosure has been made in an effort to solve the above-described problems, and it is an object of the present disclosure to provide a stowing system for vehicles that may improve the marketability of a vehicle.

It is another object of the present disclosure to provide a stowing system for vehicles that may increase user convenience.

The objects of the present disclosure are not limited to the above-mentioned objects, and other objects not mentioned herein will be clearly understood by persons of ordinary skill in the art to which the present disclosure pertains from the following description.

In order to achieve the above-described objects of the present disclosure and to perform the characteristic functions of the present disclosure, which will be described below, the features of the present disclosure are as follows.

The present disclosure provides a stowing system including a docking station, and a container including at least one component configured to receive power by being docked with the docking station. The container is configured to be separable from the docking station.

The present disclosure provides a vehicle including a docking station provided in a frunk located at a front part of a vehicle, and a container including at least one component configured to receive power by being docked with the docking station.

Other features and examples of the present disclosure are discussed infra.

As is apparent from the above description, the present disclosure provides a stowing system for vehicles that may improve the marketability of a vehicle.

The present disclosure provides a stowing system for vehicles that may increase user convenience.

The effects of the present disclosure are not limited to the effects described above, and other effects not mentioned will be clearly recognized by those skilled in the art from the above description.

The disclosure has been described in detail with reference to preferred examples thereof. However, it will be appreciated by those skilled in the art that changes may be made in these examples without departing from the principles and spirit of the disclosure, the scope of which is defined in the appended claims and their equivalents.

What is claimed is:

1. A stowing system comprising:
a docking station installed in a frunk of a vehicle; and
a container comprising at least one component configured to, based on the container being docked with the docking station, receive power,
wherein the container is configured to be separable from the docking station.

2. The stowing system of claim 1, further comprising:
a docking power supply formed on the docking station; and
a docking power connector provided on the container and configured to, based on the container being docked with the docking station, be electrically connected to the docking power supply.

3. The stowing system of claim 1, wherein the container comprises an external power connector configured to be connected to an external power source.

4. The stowing system of claim 1, wherein the at least one component comprises a heating pad disposed in the container.

5. The stowing system of claim 1, wherein the at least one component comprises a blower disposed in the container and configured to enable fluid communication between an inside of the container and an outside of the container.

6. The stowing system of claim 1, wherein the at least one component comprises a cooler configured to supply cold fluid to an inside of the container.

7. The stowing system of claim 6, wherein the cooler comprises a Peltier element.

8. The stowing system of claim 1, wherein the at least one component comprises a light emitting diode (LED) disposed in the container and configured to emit light.

9. The stowing system of claim 1, further comprising a net attached to a window formed in the container.

10. The stowing system of claim 1, wherein the container comprises:
a holder;
a lid hinged to the holder; and
a handle provided on the lid.

11. The stowing system of claim 1, wherein the container comprises a display configured to display an operating status of the at least one component and adjust an operation of the at least one component.

12. The stowing system of claim 1, wherein the container comprises:
a protrusion configured to protrude from the container; and
a partition configured to be supported by the protrusion.

13. The stowing system of claim 1, wherein the at least one component comprises:
a heating pad configured to be disposed on a bottom surface of the container; and
a blower configured to enable fluid communication between an inside of the container and an outside of the container.

14. The stowing system of claim 13, further comprising a partition capable of being held on a protrusion formed on the container,
wherein the heating pad is disposed on the partition.

15. The stowing system of claim 1, wherein the at least one component comprises:
a heating pad configured to be disposed on a bottom surface of the container;
a blower configured to enable fluid communication between an inside of the container and an outside of the container; and
a cooler configured to supply cold fluid to the inside of the container.

16. The stowing system of claim 15, further comprising a light emitting diode (LED) disposed in the container and configured to emit light.

17. The stowing system of claim 16, further comprising a net attached to a window formed in the container.

18. A vehicle comprising:
a docking station provided in a frunk located at a front part of the vehicle; and
a container comprising at least one component configured to, based on the container being docked with the docking station, receive power,
wherein the container is configured to be separable from the docking station.

19. The vehicle of claim 18, further comprising:
a control device; and
an interface associated with the control device,
wherein the control device comprises:
one or more processors; and
a memory storing instructions that, when executed, configure the one or more processors to control an operation of the at least one component; and
wherein the interface is configured to output an indication of one or more of:
the power received by the at least one component; or
the operation of the at least one component.

20. A vehicle comprising:
a docking station provided in a frunk located at a front part of the vehicle;
a container comprising at least one component configured to receive power by being docked with the docking station;
a control device; and
an interface associated with the control device,
wherein the control device comprises:
one or more processors; and
a memory storing instructions that, when executed, configure the one or more processors to control an operation of the at least one component; and
wherein the interface is configured to output an indication of one or more of:
the power received by the at least one component; or
the operation of the at least one component.
